(19) United States
(12) Patent Application Publication
(10) Pub. No.: US 2012/0209693 A1
(43) Pub. Date: Aug. 16, 2012

(54) DESKTOP ADS AND MESSAGE DISPLAY PROCESS

(76) Inventors: Marc Duthoit, Sunrise, FL (US); Helene Duthoit, Sunrise, FL (US); Eric Eva-Candela, Pompano Beach, FL (US)

(21) Appl. No.: 13/327,705

(22) Filed: Dec. 15, 2011

Related U.S. Application Data
(60) Provisional application No. 61/441,407, filed on Feb. 10, 2011.

(51) Int. Cl. G06Q 30/02

(52) U.S. Cl. 705/14.41; 705/14.66

(57) ABSTRACT

How can one be sure that marketing ads displayed on a PC are seen by the end user and not blocked by any internet pop-up blocker? How can one distribute prompt messages across an enterprise network without using email or internet explorer pop-ups? The desktop ads and messages display process concerns displaying ads of messages on the end user's desktop, detecting end user activity, and responding the various local events on the PC. The process will allow marketing ads to run on a computer without using internet pop-up windows. It will also allow display ads based on contextual information, like specific time of day or a specific PC end user action.

### CROSS REFERENCE TO RELATED APPLICATIONS

This application claims the benefit of priority of U.S. provisional application No. 61/441,407, filed Feb. 10, 2011, the contents of which are herein incorporated by reference.

### BACKGROUND OF THE INVENTION

The present invention relates to advertising apparatus and methods, and more particularly to methods and apparatus for displaying ads on an end user's personal computer (PC) desktop, detecting end user activity, and responding to various local events on the PC.

Conventional ad displays can be driven by Pop-up ads and Pop-under ads. Pop-up ads are small windows launched by an internet browser at the request of a web site in order to display various kinds of ads on the end user screen. Pop-under ads are similar to pop-up ads, but the ad window is created behind (and hidden by) the main browser window rather than being superimposed in front of it. As pop-up ads became widespread, many users learned to immediately close the popup ads that appeared over a site without looking at them. Pop-under ads do not immediately impede a user's ability to view the site content, and thus usually remain unnoticed until the main browser window is closed, at which time the user's attention is free for viewing the advertisement.

In 2000, ExitExchange Corporation filed for a patent on a subset of pop-under advertising called an exit pop. Exit pops were first introduced by ExitExchange Corporation in 1999. With exit pops, when a user leaves a web site, another site or ad appears. In 2000, ExitExchange filed for the patent on post session advertising system. After years of controversy and numerous articles on the pop-under patents, patents were awarded by the United States Patent and Trademark Office (USPTO) in April and June of 2008. The respective patent numbers are 7,386,555 and 7,353,229. The first patent, 7,386,555, is related to the method of opening an exit pop from a toolbar or software application on a computing device, and the 7,353,229 patent covers the methods used to open an exit pop from an embedded script found within a media file (e.g. JavaScript code found in a web page).

This traditional web browser type of display doesn't include any local proactive management of the ad's display. There is no local event management to decide if the ads have to be displayed or not. Therefore, the conventional ads' displays do not function when the end user is not using any internet browser (like during the PC boot up time or when the end user is running applications other than Internet Explorer). In addition, conventional ads' displays don't ensure the individual is viewing the screen at the time the ad is displayed (no user presence detection) and not logging what kind of action the end user is doing after this.

As can be seen, there is a need for an ad's display system that can show ads locally on the PC's desktop without running in the internet browser and without being launched by the internet browser.

### SUMMARY OF THE INVENTION

The present invention provides methods, apparatus, systems and prerecorded media for measuring and assessing the level of activity of an end user on his workstation, typically in a network, in order to display ads or message that have been previously downloaded on his desktop or dynamically collected from a remote server, without any other requirement, such as having an internet browser running or java script enabled.

According to one aspect of the invention, a Desktop Ad Display Process (DADP) is resident on the end user workstation, and is watching to determine whether predefined conditions for the message or ad's display match the current end user's activity.

In a further aspect of the invention, the DADP checks the end user's reaction to the ads and stores all further metrics concerning them, including predetermined stored criteria associated with them. For example, a matching condition may be declared based on day, time of day, pc usage, printer access, or input/output rate from keyboard and mouse.

In one embodiment, the DADP module decides if the ads have to be shown or if the ads have to be listed. Since the process is context dependent, the ads' displays are named, respectively, the Dynamic Information Window (DIW) and the Dynamic Information Window List (DIWL). The DIWL contains a list of message or information dedicated to the end user.

In a still further aspect of the invention, the DADP module includes a user attendance probe which senses whether the user is present at the time an exception occurs. There is no point in showing a DIW when the end user is not present.

In yet another aspect of the invention, termed herein as “reaction tracking”, the DADP module takes a snapshot of the end user's PC environment at the time that the DIW occurred, and during the following hour, at 15 minute intervals, the DADP records the identities of the software applications being used, or more particularly, the processes occurring like a connection to a website, which could identified as directly linked to the ads contained in the DIW.

In a still further aspect of the invention, the DADP is heuristic in that user's habits history is used to determine proactively if a DIW has to be shown or not shown.

The DADP also includes a threshold for not exceeding a certain number of DIW per day. Therefore, the DADP introduces a DIWL, which is local box containing all the ads for that particular day and week. When conditions are ok to have the DIWL shown, the end user is invited to click on the box to get the ads. Reaction tracking is applicable to both the DIWL and DIW.

The present invention is technically advantageous in that it takes a user-centric approach to automatically deciding when an ad (or a message) can be shown to maximize the level of attention of the end user and to evaluate the effects of this display in the next hour (the time slice could be customized). The present invention bases its assessment on activity criteria from individual user perspectives or uses a local program to show ads directly on the desktop depending on certain events, without having to have an internet browser or java script running.

External elements may be necessary, such like an operating system (OS) running on a computer and network communication.

These and other features, aspects and advantages of the present invention will become better understood with reference to the following drawings, description and claims.

### BRIEF DESCRIPTION OF THE DRAWINGS

FIG. 1 is a schematic drawing showing a DADP system flow chart according to an exemplary embodiment of the present invention;

FIG. 2 is a process flow chart showing the DIW process on the end user's PC;

FIG. 3 is a schematic diagram showing the overall network operation of the DADP system;

FIG. 4 is a flow chart showing the update protocol for the DADP running on the end user's PC; and

FIG. 5 is a pictorial representation of the ad-balancer and the ad-dispatcher, according to exemplary embodiments of the present invention.

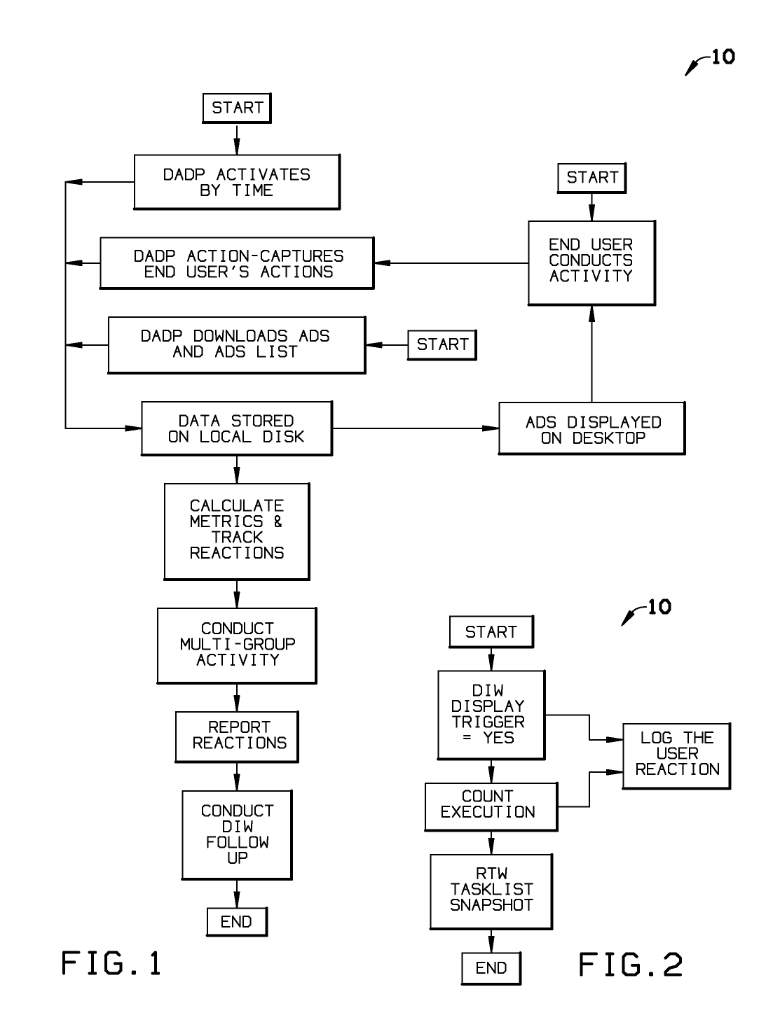

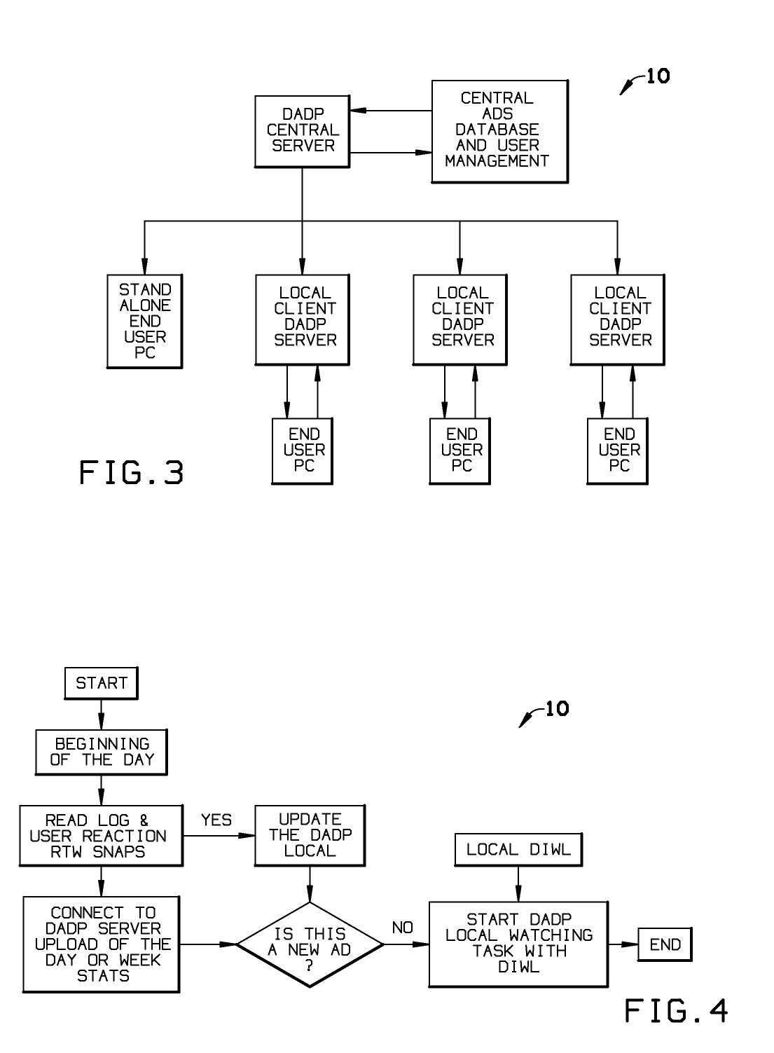

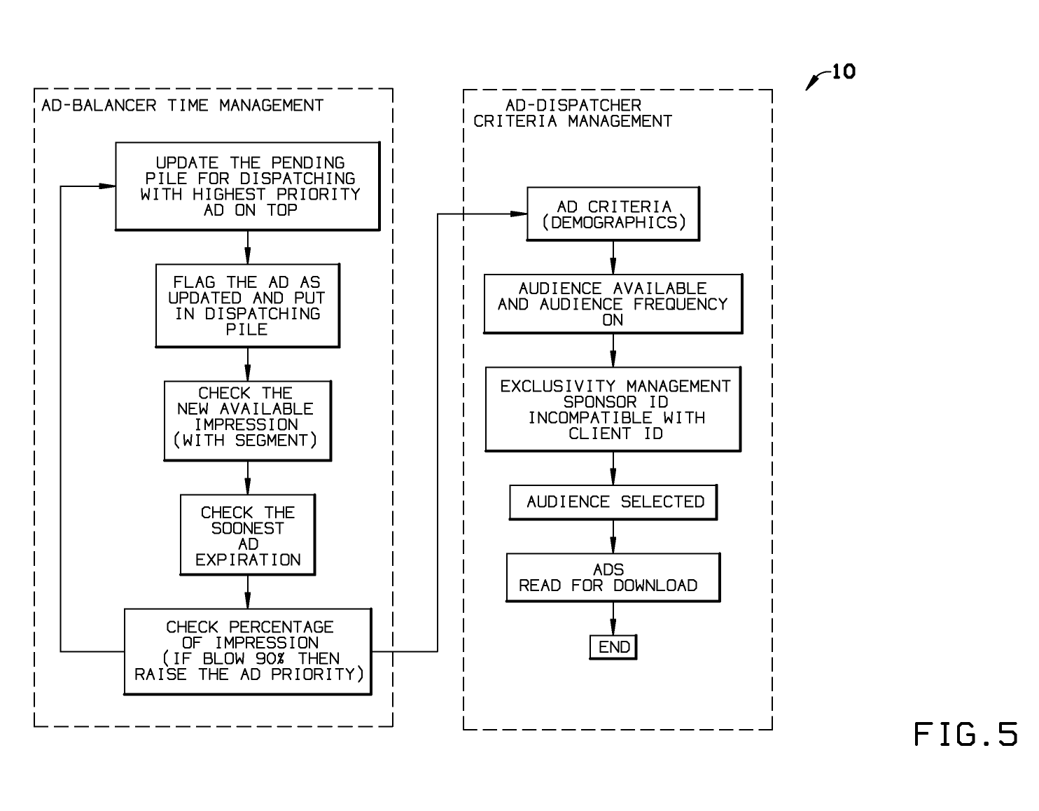

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

The following definitions are for various abbreviations used in describing the present invention. DADP refers to a Desktop Ad Display process. This is the method used to decide and display a window. The displayed window will contain “content”. Content may be, for example, an advertisement, a message or the like. DIW refers to a Dynamic Information window. This is the window to be displayed on the user's desktop. DIWL refers to a Dynamic Information Window list. This the local box on the PC which contains the ads for the EU. EU refers to the end user operating the PC or other device. RTW refers to Reaction tracking of the DIW. This is the end user trying to get more information from a particular ad.

DIW includes a set of profiles corresponding to the type of ad that is maintained centrally. The ad qualifications will be downloaded to the EU's PC. The ad qualifications include control information for the DIW. The DIW defines the thresholds used to display the ads, location parameters, duration of the display, possible actions of the EU, and the like. An example of the kind of information contained in a DIW ad profile is shown below.

TABLE 1
An exemplary DIW ad profile

| Type Management | Information 1 | Information 2 |
|---|---|---|
| Ad type | DIW Premium (on | DIWL (in the box) |
| | desktop) | |
| Boot up ad | Yes | |
| Location on the desktop | Bottom right corner, | |
| | desktop wallpaper | |
| Duration min/max | 20 s | 34 s |
| Type of file | JPG | |
| Size of the ad | Standard | |
| Action expected 1 | Click on the ad | |
| Action expected 2 | Go to www.xyz.com | |
| Frequency | Weekly | Once |
| Event (trigger) | Boot up | 11h50 AM |
| Localization | Only in NJ, NH, GA, FL | |
| Scope limitation | Car industry | |
| User Input | Collect | |

The DADP is designed for any computer running on system, such as a PC, MAC® or UNIX® system, including Ipad® and Tablet PCs. The DADP also supports thin clients like Citrix®, SMC and Virtual Desktop, as well as any PDA or Mobile Device, such as Iphone®, Android®, Blackberry® and the like. The word computer or PC, as used here within, covers all of the various end user devices.

The DADP is an autonomous local event based mechanism which is able to show any type of ad locally on the PC's desktop without running in the Internet browser or being launched by the Internet browser. The system includes an entire mechanism for distributing ads and reporting results and is working either when the PC is connected to or disconnected from a network such as the internet.

The DADP is a new generation of marketing tool, allowing small advertising messages previously downloaded on a computer or collected on the fly from an internet or remote server connection, to appear in a predefined corner in the user's desktop screen, above the other running applications or software. The DADP may make sure that the PC end user is actively using and watching the screen when the ad is displayed. The DADP also gives feedback on the number of ads displayed and the end user's action on it.

The DADP could contain any kind of marketing material, such as text, picture, small video or audio message, including a sponsored link back to the internet.

The DADP can aggregate all this information and store it on a historical database for reporting to the ad's owner (requester).

There are several novel features to the present invention. These features make this a new and innovative approach to ad display on an end user's PC.

### End User Event Based Display

The first innovation of the present invention is the use of a multidimensional, user-centric measurement. Multiple factors are monitored on the end user's machine and used to quantify the activity of the machine to decide if ads are to be displayed. The individual user's usage levels are later aggregated to produce a department, company, or enterprise global usage to determine when the ads or messages are to be displayed. This differs markedly from the traditional approach of displaying ads, which is driven by internet access or an intranet web portal rather than by a resident program which knows the end user habits and could react to a specific event like time or user action.

### Local Display by a Program on the Desktop

Another aspect of the present invention is to manage the ads which are to be displayed on the desktop in advance, and offer different modes, like DIW (dynamic information window), which appears directly before any application running on the desktop, and DIWL (dynamic information window list), which shows a list of available ads for this end user and waits for end user decision to show them.

### User Presence

Another novel factor in the DADP is the concept of user presence. The present invention may detect and record the presence or absence of the user from the workstation and use this information in the calculation of when the DIW or DIWL are to be shown. This is important to the validity of the overall ad display when a user is present than when the user is not really using the workstation.

### Heuristic Usage Modeling

This part of the invention may record the usage of each application that is running on the workstation or PC. Application performance data may be recorded locally and stored in a central database of the DADP. Each time the application is run, the model of that application's usage is updated on the central database so that a history of the normal operation of each application is built for each workstation.

Reporting can identify instances of an application operation. These application profiles may be used to evaluate and to predict the impact of an ad driven by the DIW.

### Reaction Tracking

This function provides the capability of identifying what the end user is doing during the time following the DIW's appearance on his desktop. Each time a desired action (DA) occurs, the DADP records this action and a number of factors relating to it. Among these factors is a list of current web sites visited. Over time, analysis of these exceptions identifies the exact level of reaction of the end user to the ads. The DA is a parameter list in the DIW—ads definition, as described above.

### Operational Details

### User-Centric Approach

In addition to the concept of triggering local display on the EU's PC following a specific action, the present invention describes the specific concept of showing an ad window directly on the EU's desktop without using internet explorer or java process as a launcher or a controller.

The DADP includes a mechanism which defines the maximum acceptable amount of DIW shown per day. Above this number, regardless of the action of the end user on his PC, no DIW will be shown in order to protect the end user and prevent him from being overwhelmed by ads. However, the additional ads that are available but not shown will be automatically be place in the DIWL (ad list box) and only a message will be put either on the task bar or on the desktop, informing the EU that other ads are available for him, if he clicks on the DIWL link.

In both cases, the DADP directly measures the impact of the ad (shown in the DIW or DIWL) for each user and aggregates this to a system-wide impact.

### Overall Network Operation

A central DADP server may be updated daily with two different sets of information: (1) The new Client (computer) and the topology of the network they are in, their location, and the like, and (2) The new ads. Then, depending on the profile of the ads, the Server may prepare a diffusion list toward the DADP clients or local server in case of a cascading operation mode.

Each day, the DADP client (running on the EU's PC) checks-in with its local server and gets the new ads which will be run in the DIW or DIWL. The local server does the same process with the central server.

The following paragraphs describe how the server side organization operates.

The present invention relates in general to methods and apparatus for selecting and aggregating ads to be sure they will be displayed within a selected period of time on the targeted end user's desktop screen. The system introduces three logical units: Client, Ad, and Sponsor.

The DADP server permanently updates the audience available. This corresponds to the number of computers under control of the DADP agent, the number of ads allowed per day per audience by segmentation, such as zip code, point of interest, age, and the like. This value is transmitted to an ad-balancer process.

The ad-balancer permanently reconciles the pending ads and the available audience to fuel the ad-dispatcher which is responsible for the next round of ads selected for all of the DADP clients available. This mechanism takes into consideration a matrix such as the following:

TABLE 2
Ad-balancer parameters

| | | |
|---|---|---|
| Retention date | Ad Priority | Ad ID |
| Exclusivity | Ad criteria | Ad Display Achievement |
| Available Audience | Audience frequency ON | Client exclusivity |

Retention date is the date through which the ad is displayed. Ad priority is the priority of the ad against the other ads. The closer the retention date is to the current date, the higher the ad priority. Ad ID is the identifier of the ad for cross referencing with other logical units that the ad-balancer is handling. Ad display achievement is the percentage of impressions already done. The system is designed for having 100% success most of the time. Available audience is the number of displays available on the present day or in specific selected day. Ad criteria include a list of information selected when the ad is created to narrow down the audience. This list may contain up to 20 different pieces of demographic information. Audience frequency ON determines the statistical number of days or hours per day the machine is ON for running DADP on the computer. This element influences the available impression number, e.g., if a machine is programmed with the DADP end user presence detection process as available only 3 days per week, then its impression ready number is weighted. Ad exclusivity of the system includes the possibility to create an exclusive ad, which means that any other ad containing a specific Sponsor Id (generally a competitor) will be not be displayed during the same day or week. Client exclusivity of the system includes a possibility to create exclusive ads, which means these ads could not be displayed on specific Client ID's computers.

It should be understood, of course, that the foregoing relates to exemplary embodiments of the invention and that modifications may be made without departing from the spirit and scope of the invention as set forth in the following claims.

What is claimed is:

1. A system for delivering content to a computer, comprising:
a central server, the central server containing information related to each client computer communicating with the central server, the central server further containing information about new content to be distributed to the client computers; and
an end user's computer adapted to show content locally without running in or being launched by an internet browser, the content being shown based on whether predefined conditions for displaying the content match an end user's activity.

2. The system of claim 1, wherein the system includes program code adapted to check an end user's reaction to the content and store metrics concerning the reaction.

3. The system of claim 1, wherein the predefined conditions include a specific day of the week, time of day, end user's computer usage, printer access, or input/output rate from a keyboard and a mouse.

4. The system of claim 1, further comprising a user attendance probe adapted to sense whether the user is present at the end user's computer.

5. The system of claim 1, further comprising program code for reaction tracking, wherein a snapshot of an end user's computer environment is taken at a time that the content is displayed and periodically thereafter, the snapshot including an identity of software applications being used and processes occurring on the end user's computer.

6. A desktop content display process comprising:
detecting end user activity on a personal computer;
displaying content locally on the personal computer, without requiring an internet connection to the personal computer, based on the detected end user activity; and
responding various local events on the personal computer.

7. The process of claim 6, wherein the content is displayed based on at least one of a specific day of the week, time of day, printer access, or input/output rate from a keyboard and a mouse.

8. The process of claim 6, further comprising sensing whether the user is present at the personal computer and displaying content only when the user is present at the personal computer.

9. The process of claim 6, further comprising taking a snapshot of a personal computer environment at a time that the content is displayed and periodically thereafter, the snapshot including an identity of software applications being used and processes occurring on the personal computer.

10. The process of claim 6, further comprising using a user's habits history to determine proactively if a specific content has to be shown or not shown.
